(19) United States
(12) Patent Application Publication
(10) Pub. No.: US 2008/0163108 A1
(43) Pub. Date: Jul. 3, 2008

(54) METHOD AND APPARATUS FOR DYNAMICALLY CHANGING THE POSITION OF A USER INTERFACE ELEMENT IN A USER INTERFACE

(76) Inventor: Anjali Sukumar Patil, Bangalore (IN)

Correspondence Address: SAP AG, 3410 HILLVIEW AVENUE, PALO ALTO, CA, 94304, US

(21) Appl. No.: 11/617,719

(22) Filed: Dec. 29, 2006

(51) Int. Cl. G06F 17/00

(52) U.S. Cl. 715/810

(57) ABSTRACT

Changing the position of a user interface element in a user interface (UI) of a software application during runtime, persisting the position data representing the change in position of the UI element in a database and rendering the UI using the position data from the database.

### FIELD OF THE INVENTION

The invention relates to a user interface (UI) of a software application.

### BACKGROUND OF THE INVENTION

A user interface (UI) in a software application is an interface that displays data or accepts input from a user. The UI includes UI elements such as input boxes, tables, text boxes, dropdown lists, buttons, images, etc, that help a user to view or input data to the application. The UI elements are placed in the UI in a way that enables a user to see the data and/or input the data in a convenient way.

Nevertheless, a user or a group of users may have their own preference of the way they want to see the data. For example, consider a UI that displays the details of an employee like name, employee identification number, division, location, etc, in a table with each of these attributes of the employee as a column. A first user may want to see the details in one particular order such as name, ID, division and location whereas a second user may want to see the details in a different order such as employee identification number, name, division and location. This requires the UI elements to be re-arranged according to the preference of a user. To do this, the UI has to be redesigned and/or redeveloped which involves time, effort and cost. Hence, this brings the need to be able to allow a user to personalize the UI as preferred. This includes giving a user the flexibility of changing the position of the UI elements in the UI in runtime which therefore eliminates the need to redesign and redevelop the UI. This also minimizes time, effort and cost.

### SUMMARY OF THE INVENTION

Changing the position of a user interface element in a user interface (UI) of a software application during runtime, persisting the position data representing the change in position of the UI element in a database and rendering the UI using the position data from the database.

A group of UI elements may be moved collectively and may be moved either row-wise or column-wise.

### BRIEF DESCRIPTION OF THE DRAWINGS

FIG. 1a illustrates a customer details user interface (UI) of an application.

FIG. 1b illustrates a personalization tool that is used to change the position of the UI element in a UI.

FIG. 2a illustrates the process of changing the position of the UI element in a UI using the personalization tool.

FIG. 2b illustrates the customer details UI of the application after personalizing the UI by changing the position of the UI element using the personalization tool.

FIGS. 3a and 3b illustrate a simplified flowchart for changing the position of the UI element in a UI.

FIG. 4 illustrates the various components of a system involved in changing the position of UI element in a UI.

FIG. 5 illustrates the various components of a system involved in changing the position of UI element in a UI and transferring the position data of the UI element to one or more client devices.

### DETAILED DESCRIPTION

A user interface (UI) of a software application includes UI elements such as input boxes, text boxes, radios, check boxes, buttons, tables, images that display data and/or accept input from a user. A user may want to see the data in a different order from what is initially displayed in the UI. A user may want to see the data in various different orders before deciding on one and may want to do it with minimum time and effort. In one embodiment of the invention, a personalization tool in the application enables a user to personalize the UI by changing the position of the UI element during runtime.

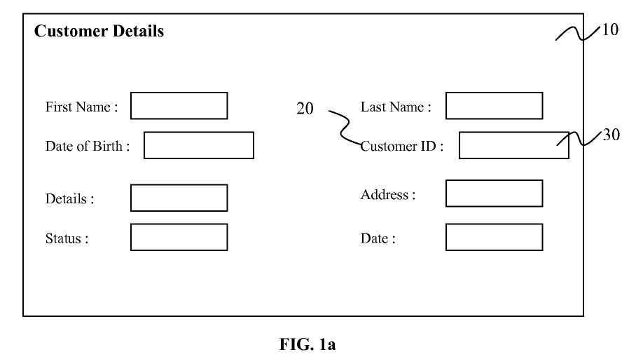

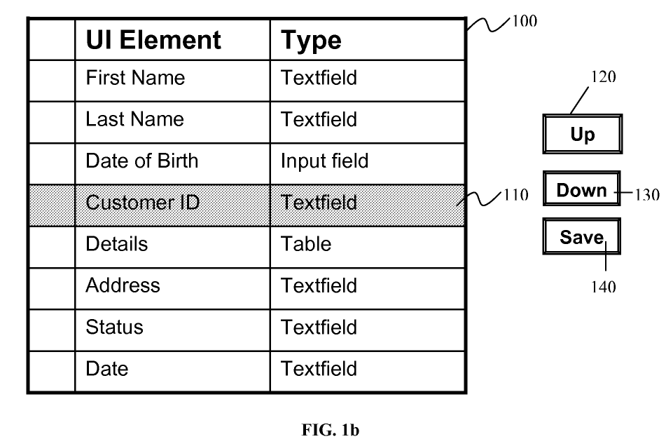

FIG. 1a illustrates a customer details UI 10 of an application. FIG. 1b illustrates one embodiment of a personalization tool through which a user can change the order, that is, the position of a UI element in the customer details UI 10. The personalization tool comprises a list 100 of one or more UI elements which correspond to the elements displayed within the customer details UI 10. The list 100 contains the name and type of the UI elements in the order they are displayed in the customer details UI 10. The personalization tool enables a user to change the position of the UI element by moving the UI element upwards or downwards within the list and then saving the changed position into a database. The above functions may be performed on the UI element by using, for example, buttons, up 120, down 130 and save 140.

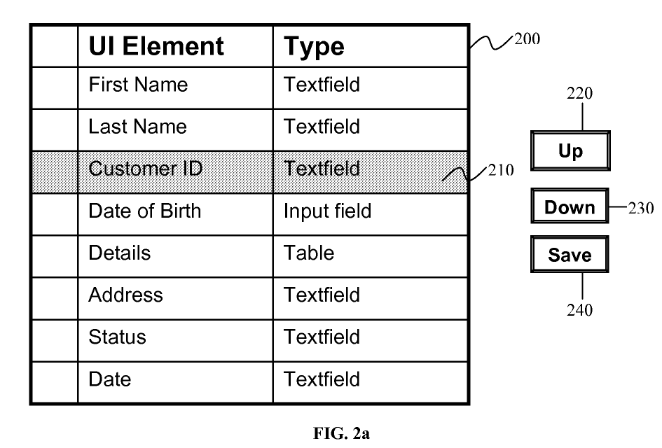

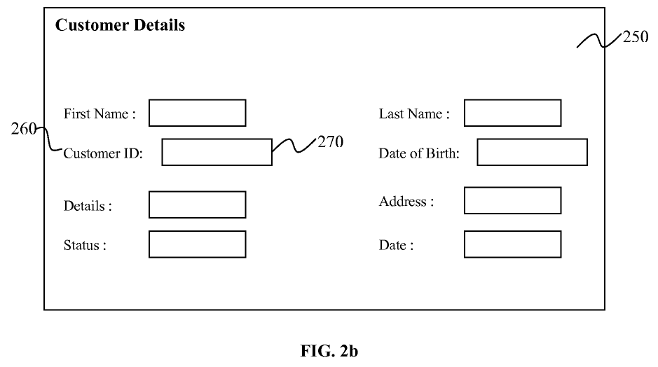

By way of example, FIG. 2a illustrates the position of the UI element, customer ID 210 being changed using the personalization tool. Specifically, the UI element, customer ID 210 of type textfield is moved up by one position by clicking the up button 220. The change in the position of the customer ID textfield 210 is then persisted into the database by clicking the save button 240.

FIG. 2b illustrates the personalized customer details UI 10 of the application resulting from the operations illustrated in FIG. 2a. The customer ID textfield 260 in FIG. 2b is moved from second column as depicted in FIG. 1a to the first column in the same row. Thus, the position of the UI element is typically changed during runtime which eliminates the need to redesign and/or redevelop the UI of the application. This minimizes the time, effort and cost of redeveloping the UI and maximizes the flexibility given to a user to personalize the UI.

In one embodiment of the invention, the personalization tool automatically moves the UI element which is associated with the moved UI element. For example, in FIG. 2b, when the customer ID textfield 260 is moved, the associated UI element, textbox 270 which displays the customer identification number, is moved along with customer ID textfield 260. This reduces the effort required from a user to manually select and move the associated textbox 270.

In one embodiment of the invention, the UI elements within the customer details UI 250 are ordered in a left-to-right and downward manner. Thus, if the customer ID textfield 20 in FIG. 1a is moved up by one position, then the customer ID textfield 260 and the textbox 270 are moved to the left, from the second column to the first column, in the same row. That is, the customer ID textfield 260 and textbox 270 are moved column-wise. If the customer ID textfield 260 is moved up by one more position when in the left-most column, then the customer ID textfield 260 and the textbox 270 are moved upward from the second row to the first row, second column. That is, the customer ID textfield 260 is moved row-wise. In this way, the UI element may be moved either row-wise or column-wise within the customer details UI 250.

In addition, one embodiment of the personalization tool as shown in FIG. 2a enables a user to move more than one UI element at a time, that is, it enables a user to select multiple UI elements form within the list 200 and move the UI elements collectively. This is accomplished by selecting more than one UI element in the UI elements list 200 in the personalization tool and selecting the up button 220 or down button 230.

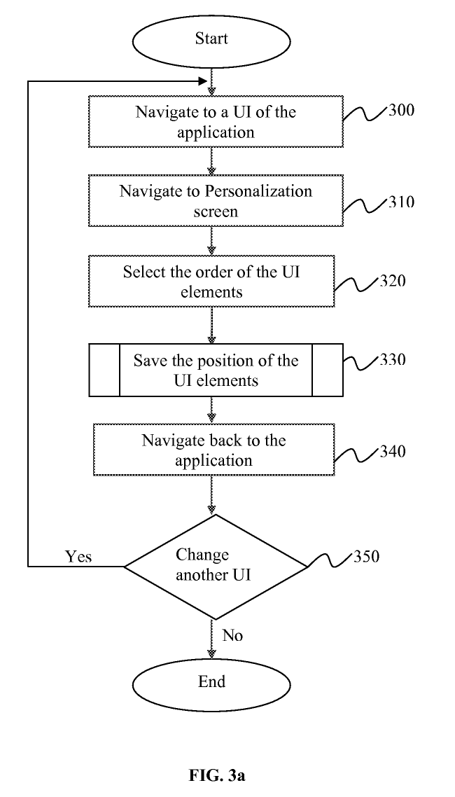

FIG. 3a illustrates one embodiment of a method for changing the position of the UI element. At 300 a user navigates to an application UI and, at 310, a personalization screen from the UI is opened. For example, in one embodiment, a user opens the personalization screen via a menu within the application or by selecting a particular shortcut key or sequence of keys. Once the personalization screen is opened, a user selects the order of the UI element using the personalization tool as depicted by 320. After the order of the position of the UI element is determined, new position data is persisted into the database as depicted by 330. The step 330 also checks if there are any associated UI elements that have to be moved and, if so, moves the associated UI element.

For example, as shown in FIG. 3b, at 360 a determination is made as to whether any associated UI element exists. If there is any associated UI element, then the change in position is determined at 370 and the position data is persisted into the database at 380. When a user returns to the customer details UI, the application fetches the position data of the UI elements from the database and renders the personalized customer details

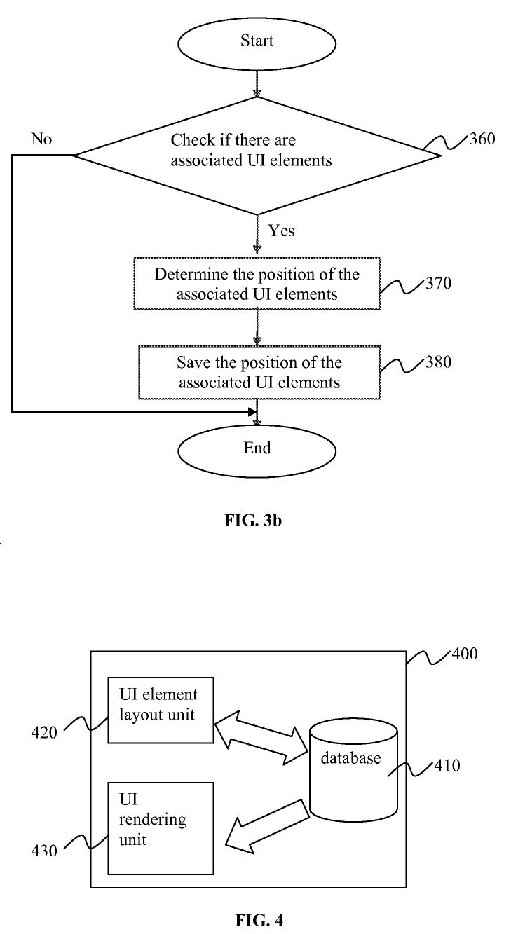

FIG. 4 illustrates the various blocks of a system 400 involved in changing the position of the UI element in the UI according to one embodiment of the invention. The system 400 includes a UI element layout unit 420, a database 410 and a UI rendering unit 430. The UI element layout unit 420 provides the personalization tool that helps in changing the position of the UI element. The database 410 includes the position data of the UI element. The UI rendering unit 430 renders the UI by fetching the position data of the UI element from the database 410.

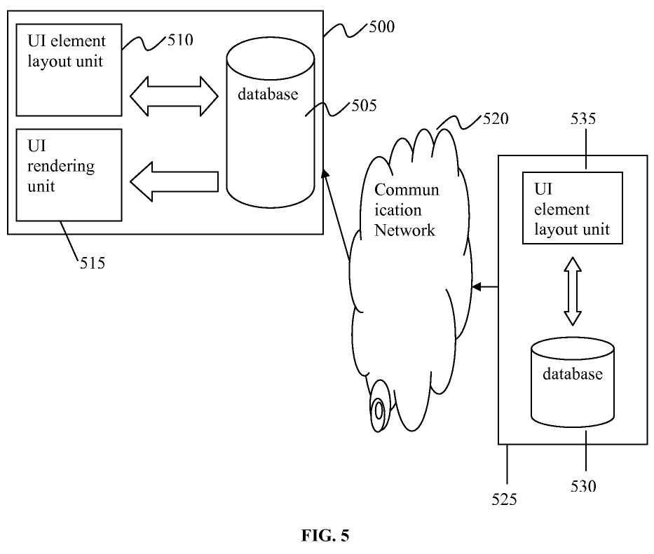

FIG. 5 illustrates a scenario wherein a server 525 sends the position data of the UI element to one or more client devices 500 over a communication network 520. Consider a sales scenario, for example, where a large retail company has a number of salesmen in different geographies. For example, the company has 100 salesmen in a first area, 100 salesmen in a second area and so on. The salesmen are equipped with mobile computing devices that run a sales application. Now, the salesmen in the first area would want to see the data in the sales application in a different way from that of the salesmen in the second area. In order to accomplish this, all the 100 salesmen in the first area may need to personalize their UI according to their preference which may be time consuming. In order to minimize the time consumed, the effort, and the inconsistency in personalizing the UI among multiple devices, a single person responsible for maintaining the application, for example, an administrator, may personalize the UI as it is required by the salesmen in the first area and in the second area on the server 525 and then send the position data of the UI element to one or more client devices 500 over a communication network 520. To accomplish the foregoing functions, the server 525 includes a UI element layout unit 535 and a database 530. The UI element layout unit 535 provides the personalization tool that helps in changing the position of the UI element in the UI. The database 530 includes the position data of the UI element. The server 525 sends the position data of the UI element in the database 530 to one or more client devices 500 over the communication network 520. The client device 500 receives the position data of the UI element and saves it in a local database 505. A local UI rendering unit 515 then renders the UI by fetching the position data of the UI elements from the database 505.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or any other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, while embodiments of the invention were described within the context of a specific customer details user interface (see, e.g., FIGS. 1a through 2b), the underlying principles of the invention may be implemented with virtually any type of user interface. Accordingly, the scope and spirit of the invention should be judged in terms of the claims which follow.

What is claimed is:

1. A method, comprising:
changing the position of a user interface element in a user interface (UI) of a software application during runtime;
persisting position data created by changing the position of the UI element in a database; and
rendering the UI using the position data from the database.

2. The method in claim 1, wherein changing the position of the UI element comprises changing the display order of the UI element in the UI through a personalization screen.

3. The method in claim 2, wherein changing the display order of the UI element in the UI comprises changing the display order of the associated UI element automatically.

4. The method in claim 2, wherein the order of the UI element may be changed by moving the UI element in a direction that includes row-wise and column-wise.

5. The method in claim 2, wherein the display order of a group of UI elements may be changed collectively.

6. The method in claim 2, wherein access to the personalization screen is restricted to authorized users.

7. A system, comprising:
a user interface element layout unit that enables changing the position of a user interface element in a user interface (UI) of a software application during runtime;
a database to store position data created by changing the position of the UI element; and
a UI rendering unit to render the UI using the position data from the database.

8. The system in claim 7, wherein the UI element layout unit displays the list of UI elements in the screen whose position may be changed.

9. The system in claim 7, wherein the UI element layout unit is executable on heterogeneous client devices with associated processing and memory capabilities.

10. The system in claim 9 further comprising a server that sends the position data of the UI element to one or more client devices over a communication network.

11. An article of manufacture, comprising:
a machine readable medium having instructions that when executed by a machine cause the machine to execute a method, comprising:
changing the position of a user interface element in a user interface (UI) of a software application during runtime;
persisting position data created by changing the position of the UI element in a database; and
rendering the UI using the position data from the database.

12. The article of manufacture in claim 11, wherein changing the position of the UI elements comprises changing the display order of the UI elements in the UI through a personalization screen.

13. The article of manufacture in claim 12, wherein changing the display order of the UI elements in the UI comprises changing the display order of the associated UI element automatically.

14. The article of manufacture in claim 12, wherein the order of the UI element may be changed by moving the UI element in a direction that includes row-wise and column-wise.

15. The article of manufacture in claim 12, wherein the display order of a group of UI elements may be changed collectively.

16. The article of manufacture in claim 12, wherein access to the personalization screen is restricted to authorized users.
